(19) United States
(12) Patent Application Publication
(10) Pub. No.: US 2021/0206210 A1
(43) Pub. Date: Jul. 8, 2021

(54) TIRE MONITOR SENSOR AND TIRE MONITOR SYSTEM FOR A VEHICLE

(71) Applicant: BCS ACCESS SYSTEMS US, LLC, Wilmington, DE (US)

(72) Inventors: MARK BAKER, Brighton, MI (US); XING PING LIN, West Bloomfield, OH (US); RICHARD MARTUS, Livonia, MI (US)

(21) Appl. No.: 16/733,336

(22) Filed: Jan. 3, 2020

(51) Int. Cl. B60C 23/04

(52) U.S. Cl. CPC B60C 23/0452; B60C 23/0493; B60C 23/0455

(57) ABSTRACT

A tire monitor sensor (16) for a vehicle has a sensor (26, 28) being adapted to measure a condition of a tire of a vehicle, a control unit (24) being connected to said sensor (26, 26) and being adapted to obtain a condition value (C) for said condition from said sensor (26, 28), said control unit (24) being configured to transmit said condition value (C) wirelessly, and a power source (20) providing electrical power to said control unit (24) via at least one terminal line (36, 38). Said terminal line (36, 38) is orientated with respect to said control unit (24) and configured to also act as an antenna partly, said control unit (24) being capable of transmitting said condition value (C) wirelessly by means of said terminal line (36, 38). Moreover, a tire monitor system is shown, said tire monitor system having a tire monitor sensor (16) and a receiver.

### FIELD OF THE DISCLOSURE

Embodiments of the present disclosure relate generally to the field of tire monitor systems monitoring the condition of the tires of a vehicle. Embodiments of the present disclosure also relate to tire monitor sensors measuring the condition of the tires of the vehicle.

### BACKGROUND

In order to monitor the tire condition of the tires of a vehicle, tire monitor sensors are known which are arranged inside the tire, e.g. directly adjacent to a valve of the tire. These tire sensors usually have a pressure sensor measuring the pressure of the air inside the tire. By means of an antenna the measured pressure value is transmitted to a receiver of the vehicle, as for example to a receiver of a central control unit of the vehicle. The central control unit will then warn the driver of the vehicle if the pressure in one or more of the tires is too low and/or if there is a puncture.

The tire monitor sensor(s) in conjunction with the receiver are also known as a tire monitor system. This system has become mandatory in many countries.

However, the tire monitor sensors known in the state of the art are complex in their structure and, therefore, their manufacturing costs are high.

### SUMMARY

Thus, there is a need to provide tire monitor sensors that are cost-effective in their production.

To address this need, among others, the present disclosure provides a tire monitor sensor for a vehicle comprising a sensor being adapted to measure a condition of a tire of a vehicle. Further, the tire monitor sensor comprises a control unit being connected to said sensor and being adapted to obtain a condition value for said condition from said sensor. Said control unit is configured to transmit said condition value wirelessly. Further, the tire monitor sensor comprises a power source providing electrical power to said control unit via at least one terminal line. Said terminal line is orientated with respect to said control unit and configured to also act as an antenna partly. Said control unit is capable of transmitting said condition value wirelessly by means of said terminal line.

Hence, the present disclosure utilizes said terminal line from said power source as an energy supply, via which electrical energy is forwarded to said control unit, and, additionally, as an antenna to transmit said tire condition wirelessly. This way, there is no need for an additional antenna as used in known tire monitor sensors. By reducing the number of necessary components, the present disclosure provides a tire monitor sensor, which is more cost-effective.

In general, it is conceivable that said energy supply also provides electrical energy to said sensor.

The terminal line may be made of a metal.

Generally, the terminal line acting as antenna (at least partly) may correspond to a patch antenna, which also comprises the printed circuit board. Particularly, the antenna corresponds to a planar inverted F-shaped antenna, namely a PIF antenna.

The terminal line can also be a part of a loop antenna, a monople antenna or a wire antenna.

For instance, the metallic terminal line and at least a portion of the printed circuit board, particularly the control unit and/or any other component, together form a resonant piece of microstrip transmission line with a length of approximately one-half wavelength of the radio waves.

Another example is that the terminal line can be used together with a trace of the printed circuit board, with the printed circuit board and/or with the power source (battery) in loop to form a loop antenna. This new loop antenna utilizes the existing terminal line of the power source (battery) as part of the antenna and saves the cost of adding extra antenna.

Accordingly, the length of the terminal line influences the wavelength of the radio waves that can be generated and/or transmitted.

Said power source may be a battery and said terminal line may be a battery terminal being connected to one pole of said battery. This way, said tire monitor sensor comprises a separate energy supply and does not rely on the energy supply of the vehicle.

For instance, said battery may be a button cell.

In one embodiment, said tire condition monitor sensor further comprises a printed circuit board. Said control unit is located on said printed circuit board. Said power source is arranged adjacent to a first side of said control unit. Said terminal line extends from said power source to a second side of said control unit, which is opposite to said first side. Thus, the antenna runs along a certain distance over said printed circuit board thereby improving the transmission efficiency. In fact, the terminal line utilized as the antenna for the control unit extends at least along the entire length of the control unit with respect to an axis defined by the extension direction of the terminal line.

For instance, said terminal line may extend along a longitudinal side of said printed circuit board. Thus, said terminal line extends over a large distance over said tire monitor sensor. Particularly, the terminal line extends substantially along the entire length of the printed circuit board.

According to one aspect of the disclosure, said terminal line may comprise a perpendicular section being perpendicular to an upper surface of said printed circuit board and a parallel section being parallel to said upper surface of said printed circuit. This way, a compact tire monitor sensor is provided.

The printed circuit board has a plate-like shape, namely a substantially 2-dimensional shape, as it has a certain length, a certain width as well as a height that is relatively small compared to the length and width of the plate-like printed circuit board. The upper surface is defined by the length and width of the printed circuit board.

Accordingly, the perpendicular section of the terminal line runs parallel with respect to the height of the printed circuit board, whereas the parallel section runs perpendicular with respect to the height of the printed circuit board.

In other words, said terminal line is at least partially L-shaped.

To set the radiation characteristics of the antenna, said parallel section may extend distanced to said upper surface of said printed circuit board by a certain amount such that said control unit is located between said printed circuit board and said terminal line. The respective distance may depend on the characteristics of the signals intended for transmission, particularly their frequency.

Provision may be made that said parallel section and said perpendicular section merge into each other at a connection point, said parallel section being connected to said power source at one end of said parallel section, said one end being opposite to said connection point. Further, said perpendicular section is connected to said printed circuit board at one end of said perpendicular section, said one end being opposite to said connection point. Thus, the shape of said terminal is similar to L-shaped antennas having good transmission characteristics.

The terminal line and a return trace on the printed circuit board (PCB) can form a loop antenna. The larger surface section formed by the terminal line and the return trace on PCB, the higher antenna radiation resistance is and the better performance it could be. This relation is also associated with the operating frequency.

To isolate the radio frequency signal transmitting said tire condition value from the other components of the said sensor, said perpendicular section may directly be connected to one side of an inductor or a capacitor.

According to an aspect of the disclosure, said tire monitor sensor may further comprise an inductor and/or a capacitor. Hence, an inductor or a capacitor may be interconnected between the control unit and the terminal line, particularly the end point of the terminal line, which is connected with the printed circuit board.

Alternatively, an inductor and a capacitor may also be interconnected between the control unit and the terminal line, particularly the end point of the terminal line, which is connected with the printed circuit board.

Generally, the inductor and/or the capacitor isolate(s) the radio frequency signals transmitted by means of the terminal line utilized as antenna.

To provide a cost-effective tire monitor sensor, said control unit may comprise a radio frequency transmitting module. Said radio frequency transmitting module is adapted to transmit said condition value by means of said terminal line acting as an antenna.

In other words, a radio frequency transmitting module is used, which is produced in large quantities. Thus, cost-effective components are used for the tire monitor sensor.

For instance, said radio frequency transmitting module may be a RF Tx module transmitting radio frequency waves with a frequency of 433 MHz.

According to an aspect of the disclosure, said radio frequency transmitting module may have an output, said terminal line may be assigned to said output of said radio frequency transmitting module. Thus, a very compact design of said tire monitor sensor is provided.

To improve the transmission efficiency, an inductor and/or a capacitor may be arranged between said terminal line and said output of said radio frequency transmitting module. Particularly, the inductor and/or the capacitor isolate(s) the radio frequency signals transmitted by means of the terminal line utilized as antenna.

In one embodiment, said power source may be a battery, said battery being connected to a printed circuit board by means of two battery terminals, wherein said battery terminals are connected to said printed circuit board. Thus, an antenna similar in size to the loop antenna of known sensors can be used in the present disclosure such that a good transmission of radio frequency waves is realized.

In other words, a loop antenna known from prior art is formed by the terminal line of the power source. Thus, the number of components is reduced and the sensor can be built in a more compact manner.

It is conceivable that said tire condition is a tire pressure and/or a tire temperature. Thus, said tire monitor sensor provides the essential information of the tire.

Further, the disclosure provides a tire monitor system for a vehicle comprising a tire monitor sensor and a receiver. Said tire monitor sensor has a sensor being adapted to measure a condition of a tire of a vehicle. Said tire sensor provides a tire condition value. A control unit is connected to said tire sensor being adapted to obtain the tire condition value for said condition from said sensor, said control being configured to transmit said tire condition value wirelessly. A power source provides electrical power to said control unit via at least one terminal line. Said terminal line is orientated with respect to said control unit and configured to also act as an antenna partly. Said control unit is capable of transmitting said condition value wirelessly by means of said terminal line to said receiver.

The respective tire monitor system may comprise the tire monitor sensor as described above as well as a receiver communicating with the tire monitor sensor. Particularly, the receiver receives the radio frequency signals transmitted by the tire monitor sensor via the terminal line.

According to one embodiment of the disclosure, said tire sensor may be a tire pressure sensor providing a tire pressure value and/or a tire temperature sensor providing a tire temperature value. Thus, said tire sensor may provide a variety of information on the tire condition.

In one aspect of the disclosure, said tire monitor sensor may continuously transmit said tire condition value and said receiver may continuously monitor said tire condition value, wherein said receiver is configured to compare said tire condition value to a reference value. This way, a possible malfunction can be detected quickly provided that a deviation is determined, particularly a deviation exceeding a pre-defined value, namely a tolerance.

It is conceivable that said reference value corresponds to a condition of the tire with low-wear. Hence, said control unit may compare said tire condition to an optimal condition, wherein the control unit may possibly alert a driver of increased wear. This improves the durability of the tires.

In another aspect, said tire monitor sensor may comprise a radio frequency transmitting module, wherein said receiver may comprise a radio frequency receiving module. Said radio frequency transmitting module is mounted on a printed circuit board. Said radio frequency transmitting module is adapted to transmit said tire condition value over said terminal line to said radio frequency receiving module. Thus, mass-produced and therefore cost-effective components can be used for the generation and the reception of radio frequency waves via which said tire condition value is transmitted.

Said receiver may be a radio frequency receiving module, for example a RF Rx module, receiving radio frequency waves at the frequency at which said frequency transmitting module is transmitting, e.g. at 433 MHz.

It is conceivable that said power source is a battery, said battery being connected to said printed circuit board by means of two battery terminals. Said battery terminals may be connected to said printed circuit board.

### DESCRIPTION OF THE DRAWINGS

The forgoing aspects and many of the attendant advantages of the claimed subject matter will become more readily appreciated as the same become better understood by reference to the following detailed description, when taken in conjunction with the accompanying drawings, wherein:

FIG. 1 shows a schematic top view of a vehicle provided with a tire monitor sensor according to the present disclosure,

FIG. 2 shows a perspective side view of a tire monitor sensor from the tire monitor system of FIG. 1 according to the present disclosure, and

FIG. 3 shows a side view of the tire monitor sensor of FIG. 2.

### DETAILED DESCRIPTION

The detailed description set forth below in connection with the appended drawings, in which like numerals refer to like elements, is intended as a description of various embodiments of the disclosed subject matter and is not intended to represent the only embodiment. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

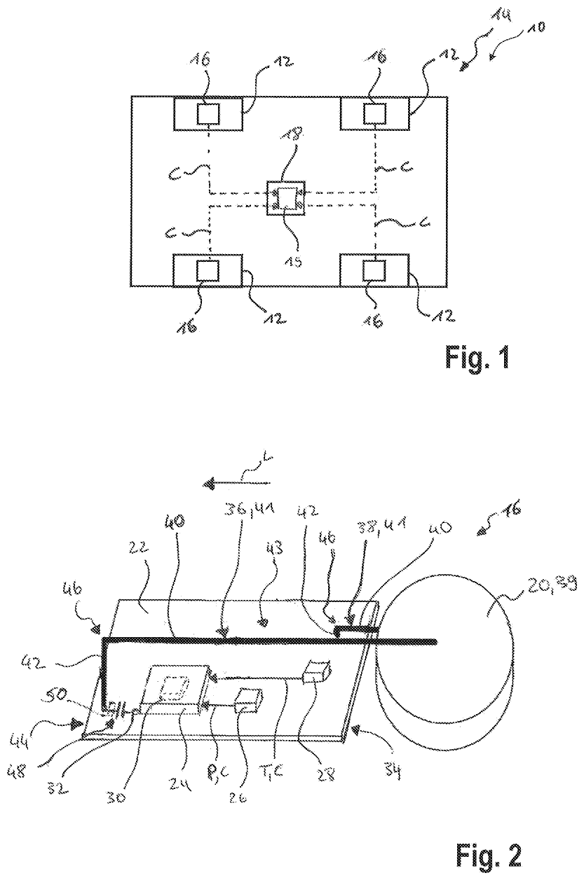

FIG. 1 shows in a schematic top-down view a vehicle 10 having four tires 12 and a tire monitor system 14.

Tire monitor system 14 comprises four tire monitor sensors 16, each being arranged in a respective tire 12, and a receiver 18 having a radio frequency receiving module 19.

Tire monitor sensors 16 are configured to communicate wirelessly with receiver 18 (indicated by the dashed arrows). Each tire monitor sensor 16 transmits a tire condition value C indicative for a tire condition of the corresponding tire 12.

In the embodiment of FIG. 1, tire monitor sensors 16 are direct tire monitor sensors 16 and each tire monitor sensor 16 transmits a radio frequency wave, namely a radio frequency signal, having information on tire condition value C to receiver 18. Receiver 18 receives the radio frequency wave by means of radio frequency receiving module 19 and determines the tire condition value C from the radio frequency wave.

To be precise, tire monitor sensor 16, located at the top left in FIG. 1, transmits tire condition value C for the corresponding tire 12, located at the top left in FIG. 1. Thus, receiver 18 receives four tire condition values C from the respective tires 12.

For instance, tire condition value C is a tire pressure value, i.e. a value indicative for the pressure of the air inside tire 12, and/or a tire temperature value, i.e. a value indicative for the temperature of the air inside tire 12 and/or for the temperature of tire 12 itself.

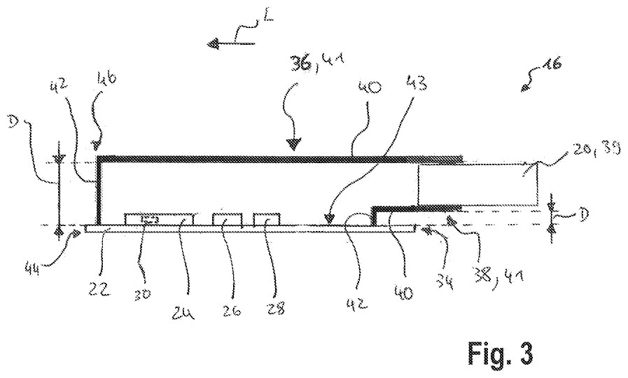

In the following, one tire monitor sensor 16 being representative for the tire monitor sensors 16 in FIG. 1 is explained in more detail by means of FIGS. 2 and 3.

FIG. 2 shows tire monitor sensor 16 in a perspective side view and FIG. 3 shows tire monitor sensor 16 in a side view. In both Figures, tire monitor sensor 16 is shown without a housing.

Tire monitor sensor 16 has a power source 20 and a printed circuit board 22, on which a control unit 24, a pressure sensor 26 providing a pressure value P, and a temperature sensor 28 providing a temperature value T are arranged.

Pressure sensor 26 and temperature sensor 28 are connected electrically to control unit 24 by means of conductor tracks (not shown) provided on printed circuit board 22.

Pressure sensor 26 may be a piezoelectric sensor providing pressure value P and/or temperature sensor 28 may be thermistor providing temperature value T.

Thus, pressure sensor 26 and temperature sensor 28 provide both a condition of the respective tire 12, as the temperature inside tire 12 and the air pressure inside tire 12.

As indicated by arrows in FIG. 2, pressure sensor 26 and temperature sensor 28 provide the pressure value P and the temperature value T, respectively, to control unit 24.

Control unit 24 comprises a radio frequency transmitting module 30 (as indicated by the dashed lines in FIG. 2) and a radio frequency output 32 (electrically) connected to radio frequency transmitting module 30.

Control unit 24 is adapted to obtain pressure value P from pressure sensor 26 and temperature value T from temperature sensor 28 with a defined sampling interval. For instance, control unit 24 obtains pressure value P and temperature value T each second if vehicle 10 is moving. Thus, the sampling interval is one second.

In general, the sampling interval may be dependent on the speed of vehicle 10 (the scan interval may become smaller with increasing speed).

By means of radio frequency transmitting module 30, control unit 24 is adapted to generate radio frequency waves having information on tire condition value C, i.e. on pressure value P and/or temperature value T. This radio frequency wave will then be sent to output 32.

In FIGS. 2 and 3, power source 20 is arranged adjacent to a first side 34 of printed circuit board 22.

Power source 20 is connected electrically to printed circuit board 22 by means of two terminal lines 36, 38 and is providing electrical power to the components located on printed circuit board 22 by means of terminal lines 36, 38 and the conductor tracks (not shown) provided on printed circuit board 22.

To be precise, power source 20 is a button cell 39 and terminal lines 36, 38 are battery terminals 41.

Terminal lines 36, 38 each have a parallel section 40 and a perpendicular section 42. In this context, the parallel and perpendicular direction refer to directions relative to a upper surface 43 of printed circuit board 22.

Parallel sections 40 extend both along a longitudinal direction L of printed circuit board 22.

In the embodiment of FIGS. 2 and 3, parallel section 40 of terminal line 36 extends essentially over the entire longitudinal side of printed circuit board 22. To be precise, parallel section 40 of terminal line 36 extends over more than 90% of the longitudinal side of printed circuit board 22.

Thus, parallel section 40 of terminal line 36 extends from first side 34 to a second side 44, which is opposite to first side 34.

Power source 20 is assigned to first side 34.

As shown in FIGS. 2 and 3, control unit 24 is arranged between printed circuit board 22 and terminal line 36.

Parallel section 40 of terminal line 38 extends only over a small fraction of the length of printed circuit board 22, i.e. over a fraction smaller than 15% of the length of printed circuit board 22.

Further, parallel sections 40 are arranged both distanced to upper surface 43 of printed circuit board 22.

In other words, parallel sections 40 are arranged at a distance D (FIG. 3) with respect to printed circuit board 22. In the embodiment of FIGS. 2 and 3, the distance D of parallel section 40 of terminal line 36 is larger than distance D of parallel section 40 of terminal line 38.

The difference between distance D of terminal line 36 and of terminal line 38 corresponds to the thickness of power source 20 in addition to the thickness of terminal line 38.

Perpendicular sections 42 extend over the corresponding distance D of parallel sections 40 from printed circuit board 22 and perpendicular sections 42 merge into corresponding parallel section 40 at a connection point 46.

In the embodiment of FIGS. 2 and 3, connection point 46 is realized by an edge in terminal line 36 and terminal line 38, respectively.

Hence, each of the terminal lines 36, 38 is made in one-piece and L-shaped, namely due to their parallel sections 40 and their perpendicular sections 42.

In fact, terminal lines 36, 38 are connected to different sides of power source 20, namely the battery cell.

At an end of parallel sections 40 of terminal lines 36, 38, the end being at an opposite side to connection point 46, parallel sections 40 are connected to different electrical poles of power source 20.

For instance, parallel section 40 of terminal line 36 is connected to the positive pole of power source 20 and parallel section 40 of terminal line 38 is connected to the negative pole of power source 20.

Further, perpendicular sections 42 of terminal lines 36, 38 are connected to printed circuit board 22 at an end of perpendicular sections 42, which is opposite to connection point 46.

In the embodiment of FIGS. 2 and 3, perpendicular section 42 of terminal line 36 is directly connected to one side of a capacitor 48, the other side of capacitor 38 being connected to radio frequency output 32 of control unit 24.

As explained above, control unit 24 provides a radio frequency wave having information on tire condition value C at output 32. Since terminal line 36 is assigned to output 32, the radio frequency wave is transmitted by means of terminal line 36 acting as an antenna (at least partly).

In the embodiment of FIG. 1 terminal line 36 forms a loop antenna, the end of loop antenna being connected with printed circuit board 22.

In fact, the loop antenna is formed by terminal line 36 that extends along control unit 24.

Control unit 24 transmits a radio frequency wave over terminal line 36 every time a new tire condition value C is provided to control unit 24. In other words, control unit 24 transmits tire condition value continuously.

The transmitted radio frequency wave is subsequently received by receiver 18 and receiver 18 determines tire condition value C from the radiofrequency wave.

For instance, receiver 18 compares the determined tire condition value C to a reference value. The reference value may be a reference pressure value and/or a reference temperature value.

In tire monitor sensor 16, the antenna as well as the power supply is realized by means of terminal lines 36, 38. This way, tire monitor sensor 16 has one component less compared to known sensors such that tire monitor sensor 16 can be built more compact and more cost-effective compared to the known sensors.

For those skilled in the art, it is obvious that FIGS. 1 to 3 have to be understood as one exemplary embodiment. For instance, the comparison of tire condition value C may as well be done by control unit 24 of tire monitor sensor 16. Tire monitor sensor 16 may then only transmit a possible warning if tire condition value C is below or above a reference value or within a predefined reference interval. Additionally, control unit 24 may transmit tire condition value C upon a request from receiver 18 or a central control unit of vehicle 10.

Further, the arrangement of control unit 24, radio frequency transmitting module 30 and sensors 26, 28 on printed circuit board 22 is only exemplary. For instance, radiofrequency transmitting module 30 may be placed as a separate component on printed circuit board 22 and/or control unit 24 and sensors 26, 28 may be designed as one component.

In addition, battery 39 may be placed on printed circuit board 22 and terminal line 38 may be realized by electrical contacts on printed circuit board 22. In this case, the radio frequency wave is transmitted only by means of terminal line 36.

Moreover, it is conceivable to use an inductor 50 instead of or additionally to capacitor 48 as illustrated by dashed lines in FIG. 2.

1. A tire monitor sensor for a vehicle, comprising:
a sensor being adapted to measure a condition of a tire of a vehicle,
a control unit being connected to said sensor and being adapted to obtain a condition value for said condition from said sensor, said control unit being configured to transmit said condition value wirelessly, and
a power source providing electrical power to said control unit via at least one terminal line,
wherein said terminal line is orientated with respect to said control unit and configured to also act as an antenna partly, said control unit being capable of transmitting said condition value wirelessly by means of said terminal line.

2. The sensor according to claim 1, wherein said power source is a battery and said terminal line is a battery terminal being connected to one pole of said battery.

3. The sensor according to claim 1, wherein said tire monitor sensor further comprises a printed circuit board, said control unit being located on said printed circuit board, said power source being arranged adjacent to a first side of said control unit, and said terminal line extending from said power source to a second side of said control unit, which is opposite to said first side.

4. The sensor according to claim 3, wherein said terminal line extends along a longitudinal side of said printed circuit board.

5. The sensor according to claim 3, wherein said terminal line comprises a perpendicular section being perpendicular to an upper surface of said printed circuit board and a parallel section being parallel to said upper surface of said printed circuit.

6. The sensor according to claim 5, wherein said parallel section extends distanced to said upper surface of said printed circuit board such that said control unit is located between said printed circuit board and said terminal line.

7. The sensor according to claim 5, wherein said parallel section and said perpendicular section merges into each other at a connection point,
said parallel section being connected to said power source at one end of said parallel section, said one end being opposite to said connection point, and
said perpendicular section being connected to said printed circuit board at one end of said perpendicular section, said one end being opposite to said connection point.

8. The sensor according to claim 7, wherein the said perpendicular section is directly connected to one side of an inductor or a capacitor.

9. The sensor according to claim 1, wherein said tire monitor sensor further comprises at least one of an inductor and a capacitor.

10. The sensor according to claim 1, wherein said control unit comprises a radio frequency transmitting module, said radio frequency transmitting module being adapted to transmit said condition value over said terminal line.

11. The sensor according to claim 10, wherein said radio frequency transmitting module has an output, said terminal line being assigned to said output of said radio frequency transmitting module.

12. The sensor according to claim 11, wherein at least one of an inductor and a capacitor is arranged between said terminal line and said output of said radio frequency transmitting module.

13. The sensor according to claim 1, wherein said power source is a battery, said battery being connected to a printed circuit board by means of two battery terminals, wherein said battery terminals are connected to said printed circuit board.

14. The sensor of claim 1, wherein said tire condition is at least one of a tire pressure and a tire temperature.

15. A tire monitor system for a vehicle comprising:
a tire monitor sensor and a receiver,
said tire monitor sensor having a sensor being adapted to measure a condition of a tire of a vehicle, said tire sensor providing a tire condition value,
a control unit being connected to said sensor and being adapted to obtain the tire condition value for said condition from said sensor, said control being configured to transmit said tire condition value wirelessly, and
a power source providing electrical power to said control unit via at least one terminal line,
wherein said terminal line is orientated with respect to said control unit and configured to also act as an antenna partly, said control unit being capable of transmitting said condition value wirelessly by means of said terminal line to said receiver.

16. The system of claim 15, wherein said tire sensor is at least one of a tire pressure sensor providing a tire pressure value and a tire temperature sensor providing a tire temperature value.

17. The system of claim 15, wherein said tire monitor sensor is continuously transmitting said tire condition value and said receiver is continuously monitoring said tire condition value, wherein said receiver is configured to compare said tire condition value to a reference value.

18. The system of claim 15, wherein said tire monitor sensor comprises a radio frequency transmitting module and said receiver comprise a radio frequency receiving module, said radio frequency transmitting module being mounted on a printed circuit board, said radio frequency transmitting module being adapted to transmit said tire condition value over said terminal line to said radio frequency receiving module.

19. The system according to claim 18, wherein said power source is a battery, said battery being connected to said printed circuit board by means of two battery terminals, wherein said battery terminals are connected to said printed circuit board.
